(19) United States
(12) Patent Application Publication
(10) Pub. No.: US 2026/0358639 A1
(43) Pub. Date: Nov. 12, 2026

(54) SPECTACLE LENS FOR A DISPLAY DEVICE WHICH CAN BE PLACED ON THE HEAD OF A USER AND WHICH GENERATES AN IMAGE, AND DISPLAY DEVICE COMPRISING SUCH A SPECTACLE LENS

(71) Applicant: tooz technologies GmbH, Aalen (DE)

(72) Inventors: Philipp Scheiderer, Nürnberg (DE); Holger Muenz, Aalen (DE); René Hensel, Aalen (DE)

(73) Assignee: tooz technologies GmbH, Aalen (DE)

(21) Appl. No.: 19/731,276

(22) Filed: Jul. 6, 2026

Related U.S. Application Data
(63) Continuation of application No. PCT/EP2025/054555, filed on Feb. 20, 2025.

(30) Foreign Application Priority Data
Feb. 21, 2024 (DE) 10 2024 104 823.9

(51) Int. Cl. G02B 27/01; G02B 27/00

(52) U.S. Cl. CPC G02B 27/0172; G02B 27/0025; G02B 2027/0178

(57) ABSTRACT

A spectacle lens for a display device that can be placed on the head of a user and generates an image has a multi-shell construction. A light guiding channel extends inside a channel shell. An inner shell takes the form of a Fresnel lens with negative refractive power. The Fresnel lens has a first lens with a Fresnel-patterned surface facing the channel shell and a second lens. The Fresnel-patterned surface has alternately curved active surfaces and interfering flanks connecting the curved active surfaces. The Fresnel-patterned surface is configured in such a way as to be free of overhang. The second lens fills the Fresnel-patterned surface in a form-fitting manner. The first lens has a lower refractive index than the second lens.

### CROSS REFERENCE TO RELATED PATENT APPLICATIONS

This application is a continuation application of international patent application PCT/EP2025/054555, filed on Feb. 20, 2025, and designating the U.S., which claims priority to German patent application 10 2024 104 823.9, filed on Feb. 21, 2024, both of which are hereby incorporated by reference in their entireties.

### FIELD OF DISCLOSURE

The present disclosure relates to a spectacle lens for a display device configured to be placed on a head of a user and to generate an image, and to a display device having such a spectacle lens.

### BACKGROUND

A spectacle lens of the type mentioned at the outset is known from WO 2015/158833 A1. Such spectacle lenses can be used, for example, in a display device that can be placed on the head of a user and generates an image, in order to provide so-called smartglasses.

Form factor and weight are critical factors in the case of such spectacle lenses since, when used as intended, the latter are used in a display device which is worn on the head of a user.

### SUMMARY

Proceeding therefrom, the problem addressed by the disclosure is that of providing a spectacle lens of the type mentioned at the outset, in which form factor and/or weight can be reduced. Furthermore, a display device having such a spectacle lens and a method of producing such a spectacle lens should be provided.

The disclosure is drawn to a spectacle lens for a display device configured to be placed on a head of a user and to generate an image for the user. Advantageous developments and exemplary embodiments are discussed below.

A spectacle lens for a display device which can be placed on the head of a user and generates an image is provided, wherein the spectacle lens comprises a front side and a back side, an entrance portion and a deflection portion spaced apart from the entrance portion, and also a light guide channel. The spectacle lens has a multi-shell structure and comprises a channel shell, in which the light guide channel extends, and an inner shell. The light guide channel extends from the entrance portion to the deflection portion and guides light beams of the generated image, which are coupled into the spectacle lens via the entrance portion of the spectacle lens, to the deflection portion (e.g., by way of at least one reflection), from where they are deflected in order to emerge from the spectacle lens via the inner shell. The inner shell is embodied as a Fresnel lens with negative refractive power and comprises a first lens element with a Fresnel-structured surface facing the channel shell, and a second lens element. The Fresnel-structured surface, which faces the channel shell, alternately comprises curved effective surfaces and dead facets connecting the curved effective surfaces and is designed such that it is free of overhangs. The second lens element fills the Fresnel-structured surface in a form-fitting manner and has a greater refractive index than the lens element.

With this exemplary embodiment of the Fresnel lens, it is possible to provide a spectacle lens which has a small form factor and is light. At the same time, it is possible to correct refractive errors by means of the Fresnel lens, with the Fresnel lens being easy to produce since its Fresnel-structured surface is free of overhangs. In particular, technically limited and costly manufacture of Fresnel structures with overhangs is not necessary. Standard processes (such as injection molding) can be used for the manufacture of the first lens element, which is free of overhangs.

The interface of the first lens element downstream of the Fresnel-structured surface can be convexly curved. This facilitates the formation or design of the Fresnel-structured surface in such a way that it is free of overhangs.

The side of the second lens element facing the channel shell can be curved. For example, an air gap may be present between the second lens element and the channel shell in this case.

The curved exemplary embodiment of the side of the second lens element facing the channel shell leads to the presence of a further optically effective surface or interface, which can be used for a refractive error correction, for example.

The side of the first lens element facing away from the channel shell can be curved.

The curved exemplary embodiment of the side of the first lens element facing away from the channel shell leads to the presence of a further optically effective surface or interface, which e.g., can be used for a refractive error correction.

At least one of the dead facets (in particular a plurality thereof or even all) of the spectacle lens can be located in a shadow region that is not optically detectable by the user when the spectacle lens is used as intended. For example, the shadow region can be a solid angle region. For example, a shadow region that is not optically detectable by the user when the spectacle lens is used as intended can be determined for each region in which a dead facet should be formed. When determining the shadow region, it is possible, in particular, to take account of the refractive index of the inner shell, the refractive index of the second lens element, the refractive power of the inner shell, the refractive power of the second lens element, the curvature of the interface downstream of the Fresnel-structured surface, the curvature of the interface of the first lens element facing away from the Fresnel-structured surface and/or the distance between the spectacle lens and eye of the user for whom the spectacle lens is intended. The distance between the spectacle lens and eye of the user is understood to mean in particular the distance of the spectacle lens from a defined point of the eye (e.g., corneal vertex or eye pivot point) during the intended use of said spectacle lens.

The light guide channel can comprise a first and a second reflection surface, which both extend from the entrance portion to the deflection portion and off which the light beams of the generated image are reflected. At least one of the two reflection surfaces can be embodied as a plane surface.

The first reflection surface and/or the second reflection surface can be realized by a refractive index jump which ensures total-internal reflection.

The refractive index jump may be present between the first shell and a layer (e.g., an adhesive layer) arranged between the first and the second or third shells.

The first reflection surface and/or the second reflection surface are/is thus formed by the interface between the first shell and the layer (e.g., the adhesive layer).

The refractive index jump may be present between the first shell and the second or third shell.

The first reflection surface and/or the second reflection surface are/is thus formed by the interface between the first shell and the first or second shell.

The first and/or second reflection surface can, e.g., be embodied such that the light beams are only reflected thereby if angle of incidence of said light beams is greater than a predetermined first limit angle. Furthermore, the first and/or second reflection surface can be embodied such that they/it are/is transmissive for angles of incidence in the range from 0° to a predetermined second limit angle of less than 90°. The second limit angle is less than or equal to the first limit angle.

These transmission/reflection properties are typically present for radiation from the visible wavelength range.

The first limit angle can be, e.g., in the range from 45° to 65°, typically in the range from 50° to 60°. The second limit angle can be, e.g., in the range from 30° to 60°, typically in the range from 35° to 45°.

The first and/or second reflection surface can have an interference layer system or be embodied as an interference layer system. The interference layer system can be formed from at least two different materials with different refractive indices. In particular, the interference layer system can comprise two, three, four, five or more different materials. The refractive indices of the materials can be in the range from 1.4 to 2.5 at a wavelength of 546 nm.

The second lens element can be manufactured from an optical polymer material containing nanoparticles (e.g., TiO₂, ZrO₂ and/or diamond nanoparticles) in particular.

Since the optical path length through the second lens element is typically of the order of a few 100 μm, scattering at such nanoparticles is probably a negligible problem. The use of nanoparticles makes it possible to set not only the dispersion but also the average refractive index of the medium.

The second lens element can be manufactured from an adhesive which cures or is cured after filling in a form-fitting manner and/or after introduction into the intermediate space between channel shell and first shell, from a thermally formable material, from a liquid (which can be encapsulated, for example) and/or a gel (which can be encapsulated, for example).

The first lens element and/or the second lens element can or can each be embodied as a GRIN (gradient index) lens. This is understood to mean in particular that the lens effect is caused by a (typically continuous) change of the refractive index in the material of the respective lens element.

The spectacle lens can comprise an outer shell which is arranged such that the channel shell is located between the inner shell and the outer shell, wherein the outer shell has positive refractive power.

The first lens element can have a refractive index n₁ and an Abbe number v₁, the second lens element can have a refractive index n₂ and an Abbe number v₂ and the outer shell can have a refractive index n₃ and an Abbe number v₃, wherein materials with such refractive indices and the Abbe numbers can be chosen such that ΔPₒᵥₑᵣₐₗₗ is as small as possible, where

$$Δ {P}_{o verall} = {ρ}_{Pull} ( \frac{{n}_{1} - 1}{{v}_{1}} - \frac{{n}_{2} - 1}{{v}_{2}} ) + {ρ}_{Push} ( \frac{{n}_{3} - 1}{{v}_{3}} ) .$$

The specification that ΔPₒᵥₑᵣₐₗₗ should be as small as possible is understood here to mean that, in particular, ΔPₒᵥₑᵣₐₗₗ is chosen such that the effective Abbe number

$${v}_{eff} = \frac{{P}_{overall}}{Δ {P}_{overall}}$$

is chosen to be greater than or comparable to typical spectacle lenses, i.e., v_{eff}>20, v_{eff}>30, v_{eff}>40 or v_{eff}>50. In this case, curvature of the side of the outer shell facing away from the waveguide is denoted ρ_{Push} and the interface of the first lens element downstream of the Fresnel-structured surface is denoted ρ_{Pull}. The overall refractive power of the spectacle lens is denoted Pₒᵥₑᵣₐₗₗ. The difference between the refractive power in the blue spectral range and the refractive power in the red spectral range is denoted ΔPₒᵥₑᵣₐₗₗ.

The material of the second lens element can fix the first lens element to the channel shell.

Further, the material of the second lens element may be tinted. The tinting can be permanent. However, it is also possible that the second lens element can be switched back and forth between tinted and non-tinted. Thus, for example, an electrochromic material and/or an electrochromic layer can be used for the second lens element.

The second lens element can have at least one active optical unit (for example liquid crystals) with adjustable refractive power. Such an active optical unit allows a tunable refractive power for the vision correction or, in combination with a further active element, enables a variably adjustable focal position of the virtual image.

Furthermore, the material used for the second lens element can be a liquid or a malleable material.

The refractive index of the second lens element (or of the medium in the intermediate space between the first lens element and the channel shell) can be adapted, for example by means of a variable proportion of admixed nanoparticles and/or the choice of a suitable polymer, which enables a continuous change in the refractive index. As a result, the overall refractive power of the Fresnel lens can be adjusted individually to the user within certain limits using the same first lens element. It is thus advantageously possible to provide individual visual correction for the widest possible target group using the fewest possible variants of first lens elements. A small number of variants allows the production processes to be standardized and the use of a smaller number of tools. Costs can thus be saved.

The advantageous angular range in which the dead facets can be aligned depends in particular on the difference in the refractive indices of the first and second lens elements of the Fresnel lens. This dependence can be used to realize individualization for different corneal vertex distances (HSAs) and different distances between the cornea and the center of rotation of the eyeball. Consequently, the same first lens element of the Fresnel lens can be used for a wider target group.

The spectacle lens can have an exit portion on the back side, through which the deflected light beams emerge from the spectacle lens. Furthermore, the light beams guided as far as the deflection portion can be deflected by the latter in the direction of the exit portion such that said light beams emerge from the spectacle lens through the exit portion and are thus coupled out of the spectacle lens.

The deflection portion and the exit portion can be spatially separate portions. However, it is also possible that the deflection portion and the exit portion coincide spatially, e.g., if the deflection portion is embodied as a surface grating.

The deflection portion in the first spectacle lens may comprise a single reflective or partially reflective deflection element or a plurality of adjacent reflective and/or partially reflective deflection elements. A desired deflection function and, if necessary, a specific imaging function of the deflection portion can be realized, for example in a Fresnel-like manner, using a plurality of adjacent reflective or partially reflective deflection elements (of course, this can also be realized using a single reflective or partially reflective deflection element). The reflective or partially reflective deflection elements can be reflective or partially reflective surface pieces, which can also be referred to as reflective or partially reflective facets. The reflective or partially reflective surface pieces can be planar in each case. However, it is also possible that the reflective or partially reflective surface pieces themselves are curved (for example spherically or aspherically curved or with a free-form shape). In the same way, the single reflective or partially reflective deflection element may be planar or curved (for example, spherically or aspherically curved or with a free-form shape).

In addition to that, or as an alternative, the deflection portion can comprise at least one holographic element, at least one volume holographic element and/or at least one diffractive element for deflection purposes.

The reflectivity of the respective reflective deflection elements (or of the single reflective deflection element) can be for example in the range of 2-100% (including the limits of the range). Thus, the reflective deflection elements can be partially reflective or reflective.

Each of the shells (especially the channel shell) can be embodied as a plane-parallel plate, as a plate with a curved side or as a plate with two curved sides. The mutually facing sides of two shells connected to each other (for example by means of an adhesive layer) can typically have mutually complementary curvatures.

In particular, the spectacle lens according to the disclosure can have a curved back side and/or a curved front side. The entrance portion can be formed in the back side and/or in the channel shell.

The light beams from the picture-generating module are typically guided by one or more reflections (in particular total-internal reflections) to the deflection portion.

If the separation plane or the surface of the first shell and/or of the further shells has changes in curvature, for example in order to influence the light conduction in the first shell, index matching of the adhesive to the first shell and/or the second or third shell is expedient, since this has a positive influence on the transparency performance.

Each of the shells can be produced from glass or a polymer.

Provision is made for a display device having a holding device which can be placed on the head of a user, a picture-generating module, which is fastened on the holding device and generates an image, and a spectacle lens according to the disclosure (including all developments) fastened to the holding device, wherein the generated image is coupled into the first shell via an entrance portion, guided in the first shell to the deflection portion by way of at least reflection and deflected at the first deflection portion in order to emerge from the spectacle lens via the inner shell such that the user can perceive it as a virtual image in the state of the holding device placed on the head.

The display device can comprise a control unit, which controls the picture-generating module. In particular, the control unit can control the picture-generating module on the basis of supplied image data.

The picture-generating module and/or a picture generator unit of the picture-generating module can in particular comprise a surface-type picture generator such as an LCD module, an LCoS module, an OLED module, a μLED or a tilt mirror matrix. Each picture generator can comprise a plurality of pixels, which can be arranged, for example, in rows and columns. For example, each picture generator can be self-luminous or non-self-luminous.

Each picture generator can typically generate a monochromatic image, wherein different picture generators can generate monochromatic images with different wavelengths.

The picture-generating module can, e.g., comprise a polychromatic picture generator, a combination of two or more monochromatic picture generators or can comprise a combination of a dichromatic picture generator and a monochromatic picture generator. Typical configurations of such picture-generating modules with a plurality of picture generators comprise a superposition unit that superimposes the light beams from the plurality of picture generators to form a common light beam. Such a superposition unit can be realized, for example, as a beam splitter cube (also called X-cube) or as a so-called rod combiner, each of which is known to a person skilled in the art.

The picture-generating module can generate the image with a first transverse chromatic aberration, which (partially or completely) compensates for a second transverse chromatic aberration in the virtual image generated by the spectacle lens.

Since the output coupling deflection portion should be as invisible as possible and the light coming from the environment to the eye of the observer should also be adversely affected as little as possible, deflection portions which have a high transmittance in transmitted light and associated therewith have a low reflectivity for the light beam or beams, which should be coupled out, of the at least two-color image are generally preferred. Typical values for the ratio of reflection to transmission are 50%, 30%, 10% or 2%, uniform over the visible wavelength range.

Provision is made for a method for producing a spectacle lens according to the disclosure (including all developments), the method comprising the following steps:
A) producing the first lens element with the Fresnel-structured surface and filling the Fresnel-structured surface with the material of the second lens element in a form-fitting manner in order to produce the Fresnel lens,
B) providing the channel shell and
C) mechanically connecting the Fresnel lens to the channel shell in order to produce the spectacle lens.

The following substeps can be carried out in step A:
A1) producing at least two different types of the first lens element with different Fresnel-structured surfaces,
A2) selecting a type of the first lens element on the basis of a desired overall refractive power of the inner shell and a distance between the spectacle lens and eye for a user for whom the spectacle lens is intended, and
A3) choosing the refractive index of the second lens element such that an adjustment is made to the desired overall refractive power of the inner shell and to the distance between the spectacle lens and eye for the user for whom the spectacle lens is intended.

The distance between the spectacle lens and eye of the user is understood to mean in particular the distance of the spectacle lens from a defined point of the eye (e.g., corneal vertex or eye pivot point) during the intended use of said spectacle lens.

The refractive index of the second lens element can furthermore be chosen in such a way in step A3 that at least one of the dead facets (especially a plurality thereof or even each of the dead facets) is located in a shadow region that is not optically detectable by the user when the spectacle lens is used as intended.

For example, the shadow region can be a solid angle region. For example, a shadow region that is not optically detectable by the user when the spectacle lens is used as intended can be determined for each region in which a dead facet should be formed. When determining the shadow region, it is possible, in particular, to take account of the refractive index of the inner shell, the refractive index of the second lens element, the refractive power of the inner shell, the refractive power of the second lens element, the curvature of the interface downstream of the Fresnel-structured surface, the curvature of the interface of the first lens element facing away from the Fresnel-structured surface and/or the distance between the spectacle lens and eye of the user for whom the spectacle lens is intended.

It goes without saying that the features mentioned above and the features yet to be explained hereinafter can be used not only in the specified combinations but also in other combinations or on their own, without departing from the scope of the present disclosure.

### BRIEF DESCRIPTION OF THE DRAWINGS

The disclosure will be elucidated in greater detail hereinafter using exemplary embodiments with reference to the appended drawings, which likewise disclose features essential to the disclosure. These exemplary embodiments serve merely for elucidation and should not be construed as restrictive. For example, a description of an exemplary embodiment with a multiplicity of elements or components should not be construed as meaning that all of these elements or components are necessary for implementation. Rather, other exemplary embodiments can also contain alternative elements and components, fewer elements or components or additional elements or components. Elements or components of different exemplary embodiments can be combined with one another, unless stated otherwise. Modifications and variations that are described for one of the exemplary embodiments may also be applicable to other exemplary embodiments. To avoid repetition, identical or mutually corresponding elements in different figures are given the same reference signs and are not elucidated again. In the drawings:

FIG. 1 shows a schematic perspective illustration of an exemplary embodiment of the display device according to the disclosure;

FIG. 2 shows an enlarged partial sectional view of the first spectacle lens including a schematic illustration of the first picture-generating module in accordance with FIG. 1;

FIG. 3 shows an enlarged partial sectional view of the first spectacle lens in accordance with FIG. 1;

FIG. 4 shows an enlarged illustration of detail B in FIG. 3;

FIG. 5 shows an enlarged illustration of a Fresnel-structured surface with an overhang;

FIG. 6 shows an enlarged partial sectional view of a spectacle lens in accordance with a further exemplary embodiment according to the disclosure;

FIG. 7 shows an enlarged partial sectional view of a spectacle lens in accordance with a further exemplary embodiment according to the disclosure;

FIG. 8 shows an enlarged partial sectional view of a spectacle lens in accordance with a further exemplary embodiment according to the disclosure;

FIG. 9 shows an enlarged partial sectional view of a spectacle lens in accordance with a further exemplary embodiment according to the disclosure;

FIG. 10 shows a schematic lens section of the Fresnel lens 15, and

FIG. 11 shows an enlarged partial sectional view of the first spectacle lens including a schematic illustration of the first picture-generating module in accordance with a further exemplary embodiment according to the disclosure.

### DETAILED DESCRIPTION OF EXEMPLARY EMBODIMENTS

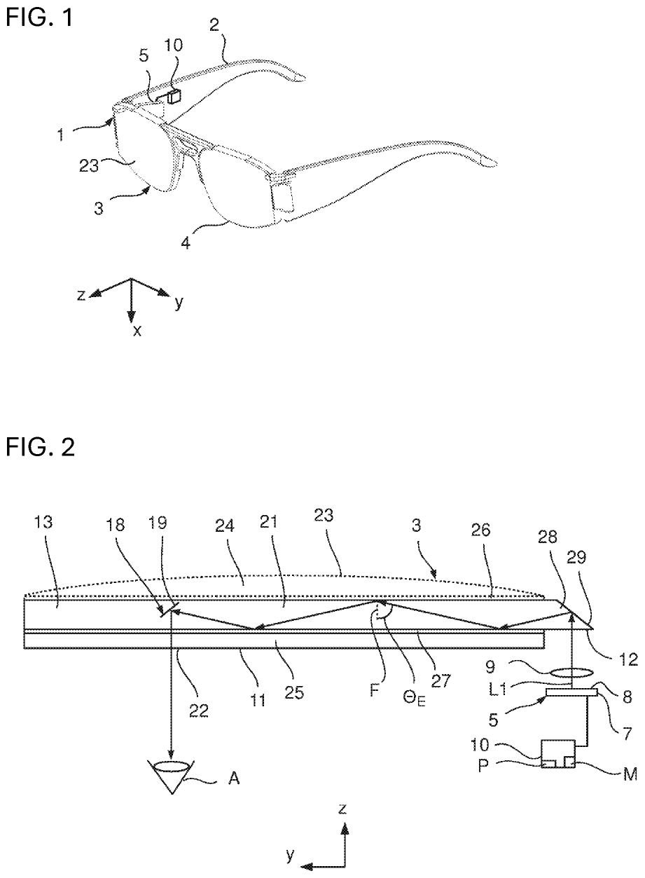

In the exemplary embodiment shown in FIG. 1, the display device 1 according to the disclosure comprises a holding device 2, which can be mounted on the head of a user and may be designed, for example, in the manner of a conventional spectacle frame, and a first and a second spectacle lens 3, 4, which are attached to the holding device 2. The first spectacle lens 3 and/or the second spectacle lens 4 can be embodied per se as spectacle lenses according to the disclosure or as spectacle lens according to the disclosure. The holding device 2 with the spectacle lenses 3, 4 can be designed, for example, as sports glasses, sunglasses, and/or eyeglasses for the correction of a refractive error, wherein a virtual image can be superimposed into the field of view of the user via the first spectacle lens 3, which can also be referred to as a multifunctional lens, as described below.

For this purpose, the display device 1 comprises a first picture-generating module 5, which can be arranged in the region of the right eyeglass temple of the holding device 2, as shown schematically in FIG. 1.

The first picture-generating module 5 may have a first picture generator unit 7 for generating a first image, as shown schematically in FIG. 2. For this purpose, the first picture generator unit 7 comprises a first extensive picture-generating element 8, downstream of which a first picture generator optics unit 9 is arranged. The first extensive picture-generating element 8 may e.g., comprise an OLED element, an LCD element, an LCoS element, a μLED or a tilt mirror matrix, each of which comprises a multiplicity of pixels arranged, for example, in rows and columns. A single light ray L1 is drawn schematically as representative of the light beams emitted by the first extensive picture-generating element 8.

As can be further seen in FIG. 2, a control unit 10 with, for example, a processor P and a memory M for controlling the first picture-generating module 5 is provided. On the basis of the supplied image data, the control unit 10, which e.g., can be arranged on the holding device 2, controls the first picture-generating module 5 and in particular the first picture-generating elements 8 such that a first image is generated in accordance with the image data. The light beams L1 emitted by the first picture-generating element 8 in the process travel through the first picture generator optics unit 9 and then enter the first spectacle lens 3. The region of the entrance can also be referred to as entrance region 12.

The first spectacle lens 3 has a multi-shell exemplary embodiment and comprises a channel shell 13 and also an outer shell 24 and an inner shell 25. The channel shell 13 is the central shell which is located between the outer shell 24 and the inner shell 25, wherein the shells 13, 24, 25 are extensively connected to one another such that a reflection surface 26 (also referred to below as outer reflection surface 26) is provided between the channel shell 13 and the outer shell 24, and a reflection surface 27 (also referred to below as inner reflection surface 27) is provided between the channel shell 13 and the inner shell 25. Alternatively, it is possible for the surface of the channel shell 13 to be the reflection surface and/or for the light in the channel shell 13 to be guided by total-internal reflection.

In the exemplary embodiment described here, the channel shell 13 is embodied as a plane-parallel plate with the exception of the region of the entrance region 12. As will be described in detail below, the inner shell 25 is embodied as a Fresnel lens 25 with negative refractive power. The outer shell 24 is embodied as a lens element with positive refractive power. The side of the outer shell 24 facing away from the channel shell 13 forms the front side 23 of the first spectacle lens 3, and the side of the inner shell 25 facing away from the channel shell 13 forms the back side 11 of the first spectacle lens 3.

The outer reflection surface 26 can be realized by an angle-dependent reflection layer 26, which only reflects the light beams L1 if its angle of incidence θ_{E} with respect to the surface normal F (shown as a dashed line in FIG. 2) of an area element at which the reflection should take place is greater than a predetermined first limit angle θ_{G}. The outer reflection surface 26 can furthermore be embodied such that it is transmissive for angles of incidence in the range from 0° to a predetermined second limit angle of less than 90°. The second limit angle is less than or equal to the first limit angle θ_{G}.

These transmission/reflection properties are typically present for radiation from the visible wavelength range.

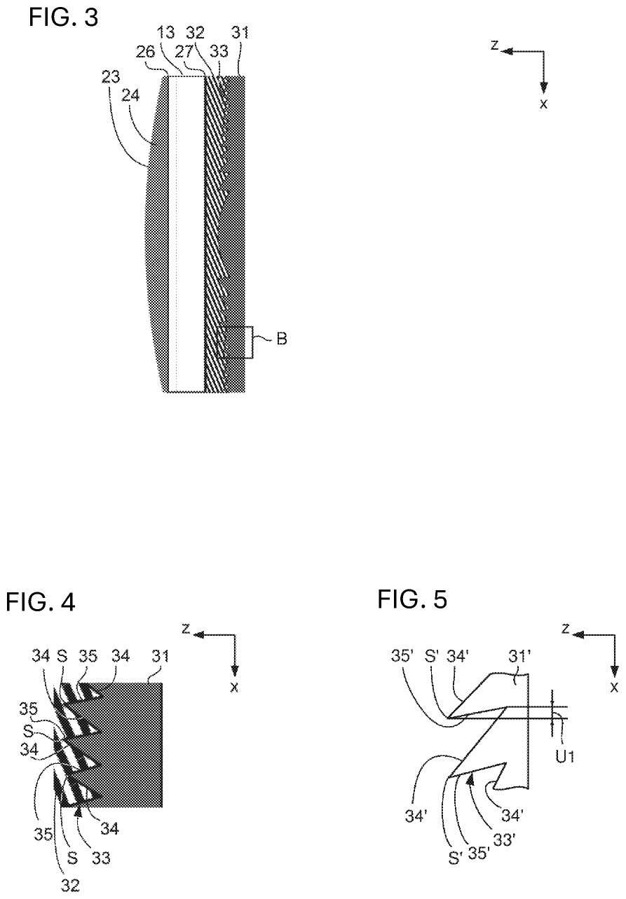

The angle-dependent outer reflection surface 26 can e.g., be embodied as an interference layer system which for example comprises thin layers with a higher and a lower refractive index in alternation. In the general case, the interference layer system can be formed of k optical layers S₁, S₂, . . . Sₖ(k>2) of m materials M₁ . . . Mₘ (m≥2) which differ in terms of their refractive indices N₁ . . . Nⱼ (j≥2). Specific examples of such an interference layer system are described, for example, in WO 2015/158833 A1 and there in particular on page 4, lines 16-30, page 9, line 34—page 10, line 31 in conjunction with FIGS. 3-5 and on page 11, lines 5-26 in conjunction with FIGS. 7-10. The corresponding disclosure is hereby incorporated into the present description.

The inner reflection surface 27 can be formed in the same way as the outer reflection surface 26

It is furthermore possible for the outer and/or inner reflection surfaces 26, 27 to be realized by a transparent adhesive layer, the refractive index of which is lower than the refractive index of the channel shell 13, wherein the refractive indices are chosen such that the light beams are guided in the channel shell 13 by total-internal reflection. The outer and/or inner reflection surfaces 26, 27 are thus formed by the interface between the channel shell 13 and the respective adhesive layer.

It is also possible for the outer reflection surface 26 to be realized by a refractive index jump between the channel shell 13 and the outer shell 24, wherein the refractive index of the outer shell 24 is lower than the refractive index of the channel shell 13. The exact refractive index values are chosen such that the light beams are guided in the channel shell 13 by total-internal reflection. The outer reflection surface 26 is thus formed by the interface between the channel shell 13 and the outer shell 24. Alternatively, the outer reflection surface 26 can be realized by a surface coating of the channel shell 13 with a material of lower refractive index.

Furthermore, the channel shell 13 comprises a buried first deflection portion 18 which comprises one (or more) partially reflective deflection element(s) 19 (multiple partially reflective deflection elements not shown in FIG. 2), which can also be referred to as a partially reflective facet 19.

As has already been described, the light beams L1 enter the first spectacle lens 3 via the entrance region 12. The entrance region 12 is formed on a lateral entrance portion 28 of the channel shell 13, which projects laterally beyond the outer and inner shells 24, 25 in the exemplary embodiment described here. The lateral entrance portion 28 comprises, in addition to the entrance region 12, a deflection region 29 (planar in this case), which deflects the light beams L1 in a first direction (the y-direction in this case) toward the deflection portion 18 such that the light beams L1 are guided in the channel shell 13 as far as the first deflection portion 18 by reflections off both reflection surfaces 26, 27. In order for this guidance in the channel shell 13 to be possible, the two reflection surfaces 26, 27 each extend from the entrance portion 28 to the first deflection portion 18.

The first deflection portion 18 then deflects the light beams L1 in such a way that the deflected light beams L1 emerge from the first spectacle lens 3 via the Fresnel lens 25 and hence via the back side 11, and thus there is a virtual image that the user can perceive with their eye A. The region via which the light beams L1 emerge can also be referred to as exit portion 22 or exit region 22.

Hence the channel shell 13 contains a first light guide channel 21, which extends along the first direction from the entrance portion 12 to the first deflection portion 18.

Since collimated light L1 with a focal plane at infinity is generally used to transport the generated image in the channel shell 13 (which can also be referred to as a waveguide), the inner shell 25 has negative refractive power in order to drag the focal position of the virtual image into the near range for the user (e.g., 0.5 m-2 m). Therefore, the inner shell 25 may also be referred to as a pull lens 25.

To view the surroundings, the influence of the pull lens 25 is compensated for by the outer shell 24 with positive refractive power. Therefore, the outer shell 24 may also be referred to as a push lens 24. However, since the outer shell 24 can also be omitted, it is shown in dashed lines in FIG. 2 (together with the outer reflection layer 26). The outer shell 24 can e.g., be omitted if the focal position of the virtual image is not adjusted. In that case, the pull lens 25 is typically only required for the refractive error correction.

Besides adjusting the focal plane of the virtual image, the pull lens 25 can be used for individual refraction correction for the ametropic user.

As can now be seen in the sectional illustration of the first spectacle lens 3 of FIGS. 1 and 2 shown in FIG. 3, the inner shell 25 has a two-part exemplary embodiment and comprises a first lens element 31 and a second lens element 32.

The first lens element 31 has a Fresnel-structured surface 33, which faces the channel shell 13. As can be seen in particular from the enlarged illustration of detail B of FIG. 3 in FIG. 4, the Fresnel-structured surface 33 comprises alternately curved effective surfaces 34 and dead facets 35 that connect the curved effective surfaces 34, wherein a desired curved interface is provided in a Fresnel-like manner by means of the curved effective surfaces 34.

The second lens element 32 is embodied such that it fills the Fresnel-structured surface 33 in a form-fitting manner. Since the second lens element 32 is manufactured from a material that has a higher refractive index than the material from which the first lens element 31 is produced, the Fresnel-structured surface 33 can be embodied such that it is free of overhangs. It can also be said that the Fresnel-structured surface 33 has no undercuts. At the same time, the inner shell 25 can have a negative refractive power.

The fact that the Fresnel-structured surface 33 is free of overhangs or has no undercuts is understood here to mean that, in particular, there is a direction from which a projection of all tips S is not located on an effective surface of the Fresnel-structured surface 33. In particular, there is a solid angle range which has an opening angle greater than 5° in at least one plane, from which a projection of all tips S is not located on an effective flank of the Fresnel-structured surface 33. For comparison, FIG. 5 shows, in the same way as FIG. 4, an enlarged detail of a Fresnel-structured surface 33′ of a solution not according to the disclosure, in which overhangs or undercuts are present. The projection of the tips S′ are located on adjacent effective surfaces 34′. There is thus an overhang U1, for example.

The inner shell 25 can thus be provided as a Fresnel lens 25 with negative refractive power, wherein the Fresnel lens 25 has aligned and buried dead facets 35 without overhang. The intermediate space between the Fresnel-structured surface 33 and the channel shell 13 is thus not filled, as is otherwise customary, with a medium having a lower optical refractive index than that of the first lens element 31 but rather, by means of the second lens element 32, with a material which has a greater refractive index than the refractive index of the material of the first lens element 31.

Typically, the material of the second lens element 32 is formable during the mounting of the first lens element 31. In particular, this is understood here to mean that the optical surface is defined by the first lens element 31 or by the Fresnel-structured surface 33, and that the material of the second lens element 32 fills the intermediate space in a form-fitting manner. In this case, the material of the second lens element 32 can be, for example, a curable adhesive, a liquid or another (for example thermally) formable material. As a result of the introduction of a material of higher refractive index between the first lens element 31 and the waveguide 13, the curvature of the boundary surface for negative refractive powers downstream of the Fresnel-structured surface 33 is convex, and so overhangs in the Fresnel-structured surface 33 are avoided.

In order to ensure total-internal reflection in the channel shell 13 on the side of the inner shell, the already described inner reflection surface 27 is arranged between the channel shell 13 and the inner shell 25.

In principle, the material of the second lens element 32 can be chosen freely for as long as it is formable and/or for as long as a form-fitting filling of the Fresnel-structured surface 33 is possible. Curing this material is not absolutely necessary. An encapsulated liquid is also possible. In this case, it is typical to provide a mechanical mount (not shown) which mounts the channel shell 13 and the inner shell 25.

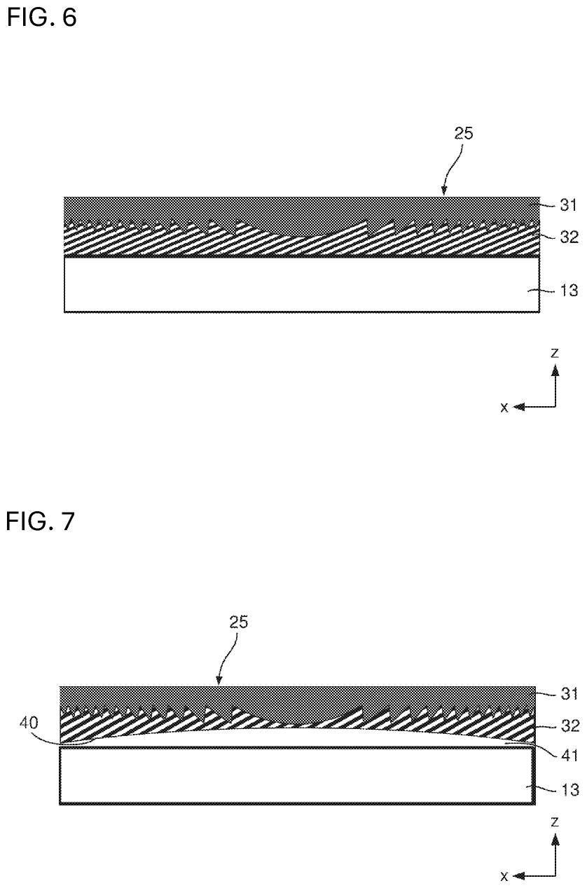

FIG. 6 schematically shows an exemplary embodiment in which there is no push lens and in which the pull lens 25 with a buried Fresnel structure has a refractive power of −6 dpt (dpt=diopter). The pull lens 25 is manufactured from PMMA (n₁=1.49), and an adhesive with n₂≈1.9 is introduced in the intermediate space toward the waveguide 13 in order to form the second lens element 32. For this refractive index combination, the optically effective surface has a radius of curvature of approximately 7 cm, and a resulting Fresnel-structured surface 33 or Fresnel surface 33 with a structure height of 0.3 mm is illustrated by way of example in FIG. 6.

The optical insulation layer 27 (or inner reflection surface 27) on the surface of the waveguide 13 facing the eye A can for example be embodied as a dielectric stack sequence, as a material with a low refractive index and/or as a porous layer with e.g., n<1.2 in order to maintain the total-internal reflection condition.

FIG. 7 schematically shows a further exemplary embodiment, wherein the materials and the Fresnel-structured surface 33 are chosen to be the same as in the exemplary embodiment described in conjunction with FIG. 6. However, in the exemplary embodiment according to FIG. 7, the second lens element 32 with a high refractive index is not used to hold the first lens element 31 on the waveguide 13. Instead, an additional optical surface 40 is provided on the side of the second lens element 32 facing away from the first lens element 31, and an air gap 41 is formed toward the waveguide 13. For example, the additional optical surface 40 of the second lens element 32 can be used for the user-specific correction of a refractive error (such as astigmatic refractive error, for example).

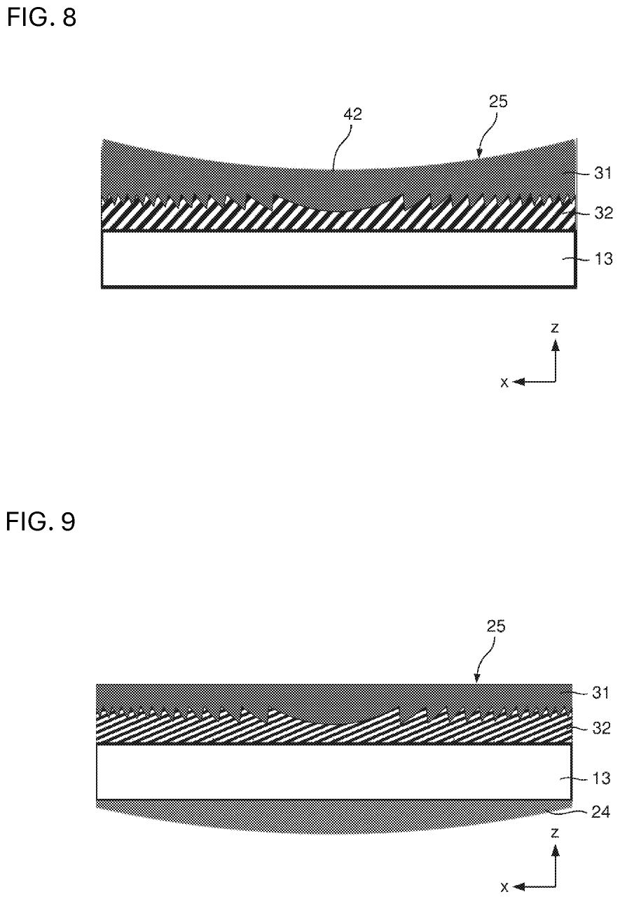

FIG. 8 shows an exemplary embodiment in which the surface 42 facing away from the waveguide 13 (which for example can be the back side 11 of the first spectacle lens 3) is not planar as hitherto but curved, such that an additional optical effect can be provided. For example, the additional optical surface 42 of the first lens element 31 can be used for the user-specific correction of a refractive error (such as astigmatic refractive error, for example). The materials and the Fresnel-structured surface 33 (or Fresnel structure 33) are chosen to be the same as in the exemplary embodiment according to FIG. 6.

It is also possible to design the pull lens 25 such that it has both curved surfaces 40 and 42 according to FIGS. 7 and 8.

In addition to the form factor, e.g., a great thickness (e.g., edge thickness), and weight, transverse chromatic aberrations are a further problem in the case of spectacle lenses with a high refractive power. The use of the Fresnel lens 25 allows advantageous form factors. In the case of the spectacle lens 3, 4 according to the disclosure, transverse chromatic aberrations can be greatly attenuated or even avoided by a suitable choice of the materials.

As shown in FIG. 9, the first spectacle lens 3 comprises the push lens 24 (with a refractive index n₃ and an Abbe number v₃) and the pull lens 25. The pull lens 25 comprises the second lens element 32 (with a refractive index n₂ and an Abbe number v₂) and the first lens element 31 (with a refractive index n₁ and an Abbe number v₁). By way of example, the optical surfaces should be spherical. The curvature of the side 23 of the push lens 24 facing away from the waveguide 13 is ρ_{Push} in this case, and the curvature on which the Fresnel surface 33 is based is ρ_{Pull}.

The overall refractive power and the chromatic refractive power error in the visible region of this lens system can be described in good approximation as follows, neglecting the distances between the lens elements 24, 31, 32:

Pₒᵥₑᵣₐₗₗ=ρ_{Pull}(n₁−n₂)+ρ_{Push}(n₃−1)

$$Δ {P}_{overall} = {ρ}_{Pull} ( \frac{{n}_{1} - 1}{{v}_{1}} - \frac{{n}_{2} - 1}{{v}_{2}} ) + {ρ}_{Push} ( \frac{{n}_{3} - 1}{{v}_{3}} ) .$$

For example, polycarbonate (n₁=n₃≈1.59, v₁=v₃≈29) is chosen as the material for both the push lens 24 and the first lens element 31. A medium having a refractive index n₂≈2.0 is used as the filling material or material of the second lens element 32. A high refractive index in the filling material can be achieved, for example, by admixing oxide nanoparticles or diamond nanoparticles in an optical polymer material.

If the push lens 24 should have a refractive power of 1 dpt and the pull lens 25 should have a refractive power of −6 dpt, then a curvature of ρ_{Push}≈1.7·1/m for the push lens 24 and a curvature of ρ_{Pull}≈14·1/m for the pull lens 25 arises with this choice of material.

In order to minimize the transverse chromatic aberrations, it is preferred that

ΔPₒᵥₑᵣₐₗₗ=0

is chosen. This is satisfied for an Abbe number of the filling material of

$${v}_{2} = \frac{{n}_{2} - 1}{\frac{{n}_{1} - 1}{{v}_{1}} + \frac{{ρ}_{Push}}{{ρ}_{Pull}} ( \frac{{n}_{3} - 1}{{v}_{3}} )} \approx 44.$$

The light used to generate the virtual image does not pass through the outer shell and therefore has a different transverse chromatic error. This can be compensated for digitally by the picture generator.

In the case of the spectacle lens 3 according to the disclosure (e.g., according to FIGS. 3 and 6 to 9), the refractive index of the medium in the intermediate space between the first lens element 31 and the waveguide 13 (in particular the refractive index of the second lens element 32) can be adjusted, e.g., by means of a variable proportion of admixed nanoparticles, enabling a continuous change in the refractive index. As a result, the overall refractive power of the pull lens 25 can be adjusted individually to the user within certain limits using the same first lens element 31. It is advantageous to provide individual visual correction for the widest possible target group using the fewest possible variants of first lens elements 31. Few variants allow processes to be standardized and a small number of tools to be used, thus saving costs. The overall refractive power P_{Pull} of the inner shell 25 can be described by

P_{Pull}=ρ(n₂−n₁)

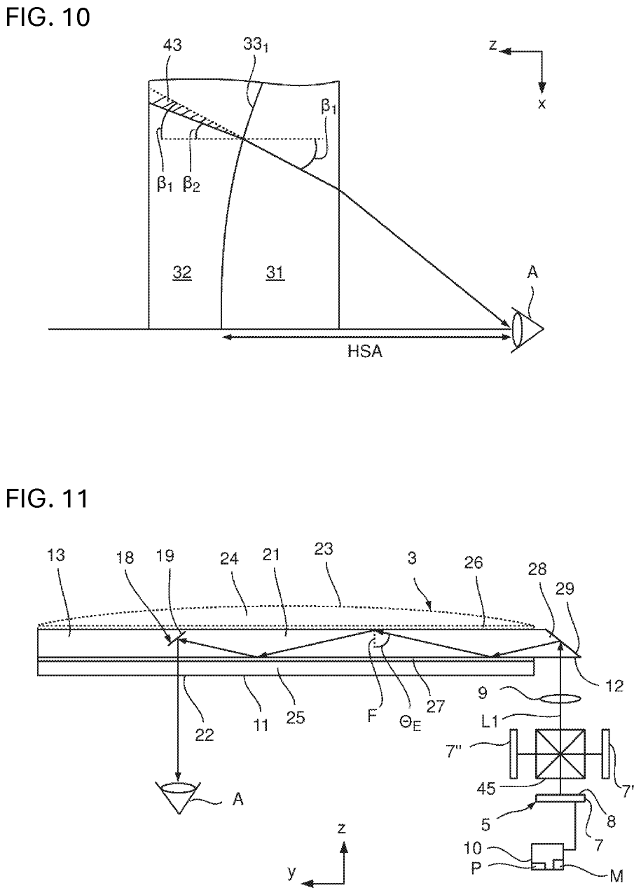

to a good approximation. Here, ρ corresponds to the curvature of the interface 33₁ downstream of the Fresnel-structured surface 33 (as illustrated in the schematic lens section in FIG. 10), n₂ is the refractive index of the medium of the second lens element 32, and n₁ is the refractive index of the medium of the first lens element 31.

An advantageous angular range 43, referred to below as shadow region 43, in which the dead facets 35 are aligned or can be located (see FIG. 10) depends on the difference between the refractive index of the first lens element 31 and the filling material of the second lens element 32. This dependence can be used to realize individualization for different corneal vertex distances (HSAs) and different distances between the cornea and the center of rotation of the eyeball. Analogously to the previous point, the same first lens element 31 can be used here for a wider target group.

The following example is used for illustration: For a first HSA, a dead facet is oriented in terms of angle β₀ such that it is located in the shadow region 43 between the angles β₁ . . . β₂.

In the case of a second HSA, which is smaller than the first HSA, and the same choice of media and surfaces, the shadow region shifts into the angular range β₁′ . . . β₂′, where β₁′>β₁ and β₂′>β₂.

Should the dead facet no longer be in the shadow region 43 in the case of the second HSA, e.g., because β₀<β₁′, it is for example possible to choose a higher refractive index n₂′ of the medium of lens element 32 in order to enlarge the shadow region 43 so that the original dead facet 35 is located in the shadow region 43 again.

The adjustment of the refractive index n₂ accordingly allows an individual adjustment to the required refractive power and the shadow zone for a wider target group starting from a small set of surfaces 33 rendered to be of the Fresnel type.

The first picture-generating module 5 and the first spectacle lens 3 are designed such that a user wearing the display device 1 according to the disclosure on their head can perceive the first image generated by means of the first picture-generating module 5 as a first virtual image with their first eye A (the right eye in this case) (FIGS. 1 and 2).

The first picture generator unit 7 may be designed to generate and output a monochromatic (and thus single-color) image. However, it can also be designed to generate and output a multicolor image.

Furthermore, it is possible to provide multiple picture generator units 7, 7′, and 7″ (FIG. 11), which, for example, generate and output a red, green and blue partial image that is then superimposed by means of superposition unit 45 (for example, a color-combiner cube) to obtain a common beam L1, as shown for the first picture-generating module 5 in FIG. 10.

Depending on the reflectivity of the deflection elements 19, the first virtual image can be perceived by the user in a manner superimposed on the environment. At a very high reflectivity and in particular at a reflectivity of 100%, the user can perceive at least in the region of the first deflection portion 18 only the first virtual image and not the environment if a specific spacing of the first deflection elements 19 is not exceeded. If the specific spacing between adjacent deflection elements 19 is exceeded, ambient light can reach the eye unhindered through them, so that even at 100% reflectivity of the deflection elements 19 a view through to the environment is possible, so that as it were a perforated/segmented 100% mirror is present.

In the display device 1 according to the disclosure, the superposition of the virtual image into the user's field of view is realized via the first spectacle lens 3. Of course, a superposition via the second spectacle lens 4 is also possible. Furthermore, the display device 1 may be designed such that information or virtual images are reflected via both spectacle lenses 3, 4. The superposition can be carried out in such a way that a three-dimensional image impression is created. However, this is not absolutely necessary.

The spectacle lenses 3, 4 may have a refractive power of zero or a refractive power different from zero (in particular for correcting a refractive error). In particular, both the front side 23 and the back side 11 may be curved. The front side 23 is in particular spherically curved. If the spectacle lens 3, 4 has a refractive power different from zero to correct a refractive error, the curvature of the back side 11 is usually chosen accordingly to achieve the corresponding correction. The back side 11 may have a curvature deviating from the spherical shape.

The holding device 2 need not be configured as a spectacle-like holding device. Any other kind of holding device by which the display device 1 can be placed and worn on the head is also possible.

The foregoing description of the exemplary embodiments of the disclosure illustrates and describes the present invention. Additionally, the disclosure shows and describes only the exemplary embodiments but, as mentioned above, it is to be understood that the disclosure is capable of use in various other combinations, modifications, and environments and is capable of changes or modifications within the scope of the concept as expressed herein, commensurate with the above teachings and/or the skill or knowledge of the relevant art.

The term “comprising” (and its grammatical variations) as used herein is used in the inclusive sense of “having” or “including” and not in the exclusive sense of “consisting only of” The terms “a” and “the” as used herein are understood to encompass the plural as well as the singular.

All publications, patents and patent applications cited in this specification are herein incorporated by reference, and for any and all purposes, as if each individual publication, patent or patent application were specifically and individually indicated to be incorporated by reference. In the case of inconsistencies, the present disclosure will prevail.

1. A spectacle lens for a display device configured to be placed on a head of a user and to generate an image, the spectacle lens comprising:
a front side and a back side;
an entrance portion and a deflection portion spaced apart from the entrance portion; and
a light guide channel,
wherein the spectacle lens has a multi-shell structure and contains a channel shell in which the light guide channel extends and an inner shell,
wherein the light guide channel extends from an entrance portion to a deflection portion and guides light beams of the generated image, which are coupled into the spectacle lens via the entrance portion of the spectacle lens, to the deflection portion, from where they are deflected in order to emerge from the spectacle lens via the inner shell,
wherein the inner shell is embodied as a Fresnel lens with a negative refractive power,
wherein the Fresnel lens contains a first lens element with a Fresnel-structured surface and a second lens element,
wherein the Fresnel-structured surface faces the channel shell and contains alternately curved effective surfaces and dead facets connecting the curved effective surfaces,
wherein the Fresnel-structured surface is configured such that it is free of overhangs,
wherein the second lens element fills the Fresnel-structured surface in a form-fitting manner, and
wherein the first lens element has a lower refractive index than the second lens element.

2. The spectacle lens as claimed in claim 1, wherein the interface of the first lens element downstream of the Fresnel-structured surface is convexly curved.

3. The spectacle lens as claimed in claim 1, wherein a side of the second lens element facing the channel shell is curved.

4. The spectacle lens as claimed in claim 1, wherein a side of the first lens element facing away from the channel shell is curved.

5. The spectacle lens as claimed in claim 1, wherein at least one of the dead facets is located in a shadow region that is not optically detectable by the user when the spectacle lens is used as intended.

6. The spectacle lens as claimed in claim 1, wherein the light guide channel comprises a first and a second reflection surface, which both extend from the entrance portion to the deflection portion and off which the light beams of the generated image are reflected, wherein typically at least one of the two reflection surfaces is embodied as a plane surface.

7. The spectacle lens as claimed in claim 1, wherein the second lens element is manufactured from an optical polymer material containing nanoparticles in particular.

8. The spectacle lens as claimed in claim 1, wherein the first lens element and/or the second lens element are/is embodied as a GRIN lens.

9. The spectacle lens as claimed in claim 1, wherein the spectacle lens comprises an outer shell which is arranged such that the channel shell is located between the inner shell and the outer shell,
wherein the outer shell has a positive refractive power.

10. The spectacle lens as claimed in claim 9,
wherein the first lens element has a refractive index n₁ and an Abbe number v₁, the second lens element has the refractive index n₂ and the Abbe number v₂ and the outer shell has the refractive index n₃ and the Abbe number v₃,
wherein the effective Abbe number
$${v}_{eff} = \frac{{P}_{overall}}{Δ {P}_{overall}}$$
is selected such that it is greater than 20, 30, 40 or 50,
wherein a curvature of the side of the outer shell facing away from the channel shell is denoted ρ_{Push}, the interface of the first lens element downstream of the Fresnel-structured surface is denoted ρ_{Pull}, and an overall refractive power of the spectacle lens is denoted by Pₒᵥₑᵣₐₗₗ, where
$$Δ {P}_{overall} = {ρ}_{Pull} ( \frac{{n}_{1} - 1}{{v}_{1}} - \frac{{n}_{2} - 1}{{v}_{2}} ) + {ρ}_{Push} ( \frac{{n}_{3} - 1}{{v}_{3}} ) .$$

11. The spectacle lens as claimed in claim 1, wherein the material of the second lens element fixes the first lens element to the channel shell.

12. The spectacle lens as claimed in claim 1, wherein the material of the second lens element is tinted.

13. The spectacle lens as claimed in claim 1, wherein the second lens element can be switched back and forth between tinted and non-tinted.

14. The spectacle lens as claimed in claim 1, wherein the second lens element comprises at least one active optical unit with an adjustable refractive power.

15. The spectacle lens as claimed in claim 1, wherein the material used for the second lens element is a liquid or a malleable material.

16. A display device comprising:
a holding device configured to be placed on the head of a user;
a picture-generating module, which is fastened on the holding device and generates an image; and
the spectacle lens as claimed in claim 1, fastened to the holding device,
wherein the generated image is coupled into the first shell via an entrance portion, guided in the first shell to the deflection portion by way of at least reflection and deflected at the first deflection portion in order to emerge from the spectacle lens via the inner shell such that the user can perceive it as a virtual image in a state of the holding device being placed on the head of the user.

17. The display device as claimed in claim 16, wherein the picture-generating module generates the image with a first transverse chromatic aberration, which compensates for a second transverse chromatic aberration in the virtual image generated by the spectacle lens.

18. A method for producing a spectacle lens as claimed in claim 1, comprising the following steps:
A) producing the first lens element with the Fresnel-structured surface and filling the Fresnel-structured surface with the material of the second lens element in a form-fitting manner in order to produce the Fresnel lens;
B) providing the channel shell; and
C) mechanically connecting the Fresnel lens to the channel shell in order to produce the spectacle lens.

19. The method as claimed in claim 18,
wherein the following substeps are carried out in step A:
A1) producing at least two different types of the first lens element with different Fresnel-structured surfaces;
A2) selecting a type of the first lens element on the basis of a desired overall refractive power of the inner shell and a distance between the spectacle lens and eye for a user for whom the spectacle lens is intended; and
A3) choosing the refractive index of the second lens element such that an adjustment is made to the desired overall refractive power of the inner shell and to the distance between the spectacle lens and the eye.

20. The method as claimed in claim 19, wherein the refractive index of the second lens element is chosen in such a way in step A3 that at least one of the dead facets is located in a shadow region that is not optically detectable by the user when the spectacle lens is used as intended.
